(19) United States
(12) Patent Application Publication
(10) Pub. No.: US 2008/0274705 A1
(43) Pub. Date: Nov. 6, 2008

(54) Automatic tuning of telephony devices

(76) Inventor: Mohammad Reza Zad-Issa, Irvine, CA (US)

Correspondence Address: BRAKE HUGHES BELLERMANN LLP;c/o Intellevate, P.O. Box 52050, Minneapolis, MN, 55402, US

(21) Appl. No.: 11/799,533

(22) Filed: May 2, 2007

(51) Int. Cl. H04B 1/40

(52) U.S. Cl. 455/77

(57) ABSTRACT

Various embodiments are disclosed relating to the automatic tuning of telephony devices. An example method comprises, determining, based on a change in an operating environment of a telephony device, that a speech enhancement algorithm of the telephony device is to be tuned. The example method further comprises, determining one or more metrics based on operation of the telephony device in the changed operating environment and providing the one or more metrics to the speech enhancement algorithm In the example method, the speech enhancement algorithm is tunable based on the one or more metrics. The example method still further comprises, tuning the speech enhancement algorithm based on the one or more metrics.

### TECHNICAL FIELD

This description relates to the tuning of telephony devices.

### BACKGROUND

Telephony devices are used to communicate audio, including speech and music, from one location to another via signals traveling across one or more networks. Such telephony devices, upon receiving speech or other audio from a user, and/or the networks, may perform audio enhancement processing on the received audio.

Audio enhancement components may be initialized, tuned or otherwise configured to operate in an ideal or assumed operating environment in which the telephony device operates. For example, the audio enhancement components may be configured to work with a generic model of the telephony device. However, over time, features of the physical operating environment, including the components of the telephony device, may change, be replaced and/or stop working. Such changes may negatively affect the quality of the audio processing being performed by the audio enhancement components.

### SUMMARY

Methods and apparatus for tuning telephony devices are disclosed herein. An example method comprises, determining, based on a change in an operating environment of a telephony device, that a speech enhancement algorithm of the telephony device is to be tuned. The example method further comprises, determining one or more metrics based on operation of the telephony device in the changed operating environment and providing the one or more metrics to the speech enhancement algorithm. The speech enhancement algorithm, in the example method, is tunable based on the one or more metrics. The example method still further comprises, tuning the speech enhancement algorithm based on the one or more metrics.

Another example method comprises, monitoring an operating environment of a telephony device, including performance of a speech enhancement algorithm of the telephony device. This example method further comprises, determining, as a result of the monitoring, a change in the operating environment affecting the performance of the speech enhancement algorithm. This example method still further comprises, determining one or more metrics based on operation of the telephony device in the changed operating environment and providing the one or more metrics to the speech enhancement algorithm. In this example method, the performance of the speech enhancement algorithm is tunable based on the one or more metrics.

An example apparatus comprises a telephony device configured to operate in an operational mode or a tuning mode, where the telephony device includes a speech enhancement algorithm. In the example apparatus, the speech enhancement algorithm is tunable based on one more metrics associated with performance of the telephony device when operating in an operating environment. Also in the example apparatus, the telephony device, while operating in the tuning mode, is configured to provide the one or more metrics to the speech enhancement algorithm for tuning.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system that provides for the automatic tuning of telephony devices according to an example embodiment.

FIG. 2 is a block diagram of an example system that provides for the automatic tuning of telephony devices according to an example embodiment.

FIG. 3 is a block diagram of an example system that provides for the automatic tuning of telephony devices according to an example embodiment.

FIG. 4 is a flowchart illustrating example operations of the system of FIG. 1.

FIG. 5 is a flowchart illustrating example operations of the system of FIG. 1.

### DETAILED DESCRIPTION

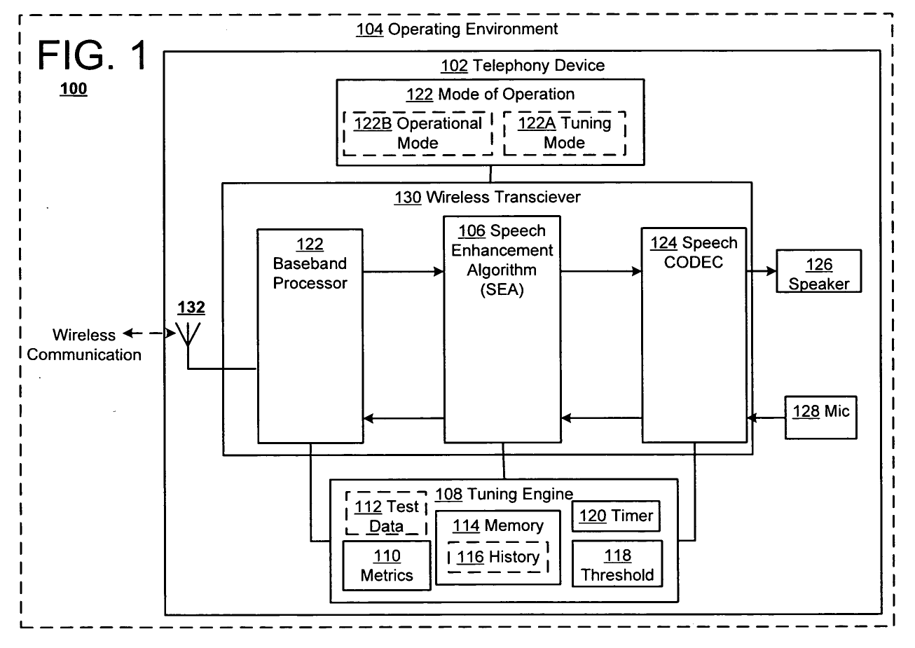

FIG. 1 is a block diagram of an example system 100 that may provide for the automatic tuning of telephony devices according to an example embodiment.

The system 100 may include a telephony device 102 that is configured to perform audio processing on audio data, including speech, provided to the device. Over time, such as during the course of usage of the telephony device 102, an operating environment 104, including a physical environment in which the telephony device 102 is implemented and/or otherwise operates, may change. For example, the cover of the telephony device 102 may break, audio components may go bad and/or be replaced, accessories may be added and/or the telephony device 102 may be configured to communicate with other devices. These and other changes in the operating environment 104 may impact not only the appearance of the telephony device 102, but also the audio processing characteristics of the telephony device 102 by, for example, changing the acoustic qualities of the telephony device 102.

The system 100 may determine how changes in the operating environment 104 in which the telephony device 102 operates impact the audio processing characteristics and/or other acoustic qualities of the telephony device 102 and provide metrics 110 to one or more audio processing components of the telephony device 102. Such audio processing component(s) may then be updated or tuned based on the metrics 110 associated with the changes in the operating environment 104, such that audio processing of the telephony device 102 performed by its audio components may be improved and/or otherwise account for the changes in the operating environment 104.

As referenced above, the system 100 may include a telephony device 102. The telephony device 102 may include an audio device configured to receive audio communication, including speech, voice, music and/or other audio data, perform audio processing on the received audio communication and provide the processed audio to another device. The telephony device 102 may comprise, for example, a mobile phone or a wireless headset, such as a Bluetooth compatible headset configured to communicate with a mobile phone. In other example embodiments, the telephony device 102 may comprise additional and/or different telephony and/or audio devices.

Also as referenced above, the telephony device 102 may operate in the operating environment 104. The operating environment 104 may include the physical environment in which the telephony device 102 operates. For example, the operating environment 104 may include the material, shape and/or the acoustic and/or mechanical design of the telephony device 102. Further, the operating environment 104 may include audio components of the telephony device 102 used to receive, process and/or output speech. For instance, a microphone 128 may be used to receive speech from a user. The operating environment 104 may also include supplementary components and/or peripheral devices that are operationally coupled with the telephony device 102. For example, the telephony device 102 may take the form of a headset and include a wireless headset with a cotton earpiece cover (e.g., a supplementary component) for the user's comfort and/or may communicate with a mobile phone (e.g., a peripheral device).

The telephony device 102 may include one or more speech and/or audio processing components, including a speech enhancement algorithm (SEA) 106. The SEA 106 may include a speech and/or other audio processing component configured to process and/or enhance audio signals and/or audio data. For example, the SEA 106 may include an echo canceller, an echo suppressor, a noise reduction module, an automatic volume boost/reduction module, an automatic gain control module, a noise dependent equalization module, and/or other speech or audio processing components.

According to an example embodiment, the SEA 106 may be tuned or otherwise configured using one or more characteristics of the telephony device 102 and/or the operating environment 104. For example, when first configured, the SEA 106 may be tuned based on a generic model and/or manufacturer specifications associated with the telephony device 102. However, due at least in part to manufacturing variations, such as temperature and materials, the generic model of the telephony device 102 and/or the manufacturer specifications may not be an accurate representation of the telephony device 102 on which the SEA 106 is actually operating. Furthermore, during the course of use of the telephony device 102 by a user, the physical qualities (e.g., the operating environment 104) of the telephony device 102 may change and introduce further discrepancies from the original and/or generic model on which the SEA 106 may have been initially tuned.

The differences between characteristics of the operating environment 104 on which the SEA 106 was originally tuned and changes to the operating environment 104 over time may cause a degradation in the performance (e.g., audio and/or speech processing) of the SEA 106 as the SEA 106 may be processing audio and/or speech information based on an outdated representation of the operating environment 104. For example, over time one or more audio components of the telephony device 102 may degrade, stop working and/or be replaced, which may impact the acoustic quality of at least some of the audio being provided to and/or from the SEA 106. The SEA 106, however, may be tuned to the operating environment 104 prior to the change(s). This may cause, for example, degradation in the audio processing performed by the SEA 106, as it is processing audio based on an outdated representation of the operating environment 104.

A tuning engine 108 may provide the SEA 106 and/or other audio processing components of the telephony device 102 with updated metrics 110 associated with the changes in the operating environment 104 impacting the telephony device 102. For example, the tuning engine 108 may test or otherwise track the performance of one or more components of the telephony device 102. Then, for example, the tuning engine 108 may determine whether a change in the operating environment 104 has impacted the performance of the telephony device 102 and, if so, provide the metrics 110 associated with the impact on the telephony device 102 to the SEA 106. According to an example embodiment, the tuning engine 108 may only determine material changes in the operating environment 104, which may include any differences that may affect the performance and/or acoustic quality of the telephony device 102.

The metrics 110 may include parameters or other metrics associated with audio performance/operation of the telephony device 102. For example, the metrics 110 may measure, gauge or otherwise track the performance and/or operation of the telephony device 102 in the operating environment 104. The metrics 110 may be used, for example, to determine how changes in the operating environment 104 impact the operation of the telephony device 102 including, for example, processing audio signals.

As referenced above, according to an example embodiment, the initial metrics may be determined based on a manufacturer data sheet and/or a generic model of the telephony device 102. Then, for example, as the operating environment 104 changes, the tuning engine 108 may determine new, updated metrics 110 based on the changed operating environment 104.

According to an example embodiment, the tuning engine 108 may determine the metrics 110 based, at least in part, on processing of test data 112 by the telephony device 102. The test data 112 may include audio data that may be provided to one or more components of the telephony device 102 to determine whether and/or how changes in the operating environment 104 affect the performance of the telephony device 102. For example, the test data 112 may include pre-recorded speech with known characteristics, such that after the processing of the test data 112 by the telephony device 102, the processed test data may be compared to the original test data 112 (e.g., by the tuning engine 108) to determine the metrics 110 associated with the performance of the telephony device 102 and/or whether the audio processing of the telephony device 102 has been affected by the change(s) in the operating environment 104.

The tuning engine 108 may include a memory 114. The memory 114 may store information pertaining to the performance of the telephony device 102 and/or operating environment. For example, the memory 114 may include a history 116.

The history 116 may include a log, or history of operating parameters corresponding with the performance of the telephony device 102 and/or one or more of its components. For example, the history 116 may include a log of the metrics 110 at different points in time. Then, for example, based on the history 116, the tuning engine 108 may determine whether the metrics 110 are consistent with past performance of the telephony device 102 and, in turn, whether a change may have occurred in the operating environment 104. If the tuning engine 108 determines that a change has occurred in the operating environment 104 (e.g., the performance of the telephony device 102 has deviated from past performance by greater than a threshold 118), the tuning engine 108 may provide the metrics 110 for use in updating or retuning the SEA 106 based on the changes in the operating environment 104.

The threshold 118 may represent an expected and/or acceptable range of performance variation for the telephony device 102. For example, the telephony device 102 may normally operate within a certain metric range, or threshold 118. Then, for example, one or more changes in the operating environment 104 may cause the performance of the telephony device 102 to change such that the metrics 110 may deviate beyond the threshold 118, thus indicating the SEA 106 may need to be retuned to account for the changes in the operating environment 104. According to an example embodiment, the threshold 118 may be provided by the manufacturer of the telephony device 102 and/or may be determined based at least in part on the history 116.

The tuning engine 108 may include a timer 120. The timer 120 may determine how often, or when the tuning engine 108 is to determine the metrics 110 and/or when the SEA 106 is to be retuned. For example, the timer 120 may be set such that every 6 months the metrics 110 are determined and provided to the SEA 106. Alternatively, the timer 120 may be set such that every 2 months, upon its expiration, the metrics 110 are determined and stored in the history 116. Then, for example, when the tuning engine 108 determines (e.g., by comparing the metrics 110 to the history 116) that the operating environment 104 has changed, the SEA 106 may be provided the metrics 110 and retuning may be performed.

The telephony device 102, according to an example embodiment, may include a mode of operation module 122 comprising two modes of operation for the telephony device 102, a tuning mode 122A and an operational mode 122B.

While operating in the operational mode 122B, the telephony device 102 may exchange and process audio data, including speech, with one or more devices and/or users. For example, the telephony device 102 may include a mobile phone that sends/receives speech with one or more telephony devices while in the operational mode 122B. Further, during operation in the operational mode 122B, the tuning engine 108, according to an example embodiment, may remain idle or otherwise inactive.

While operating in the tuning mode 122A, the telephony device 102 may operate as if operating in the operational mode 122B as just described, (or in other example embodiments one or more operations of the telephony device 102 may be disabled or otherwise inactive), however, the tuning engine 108 may be active as well. The active tuning engine 108 may determine and/or provide the metrics 110 to the SEA 106 to be updated or tuned as described above.

In addition to the SEA 106, the telephony device 102 may include one or more other audio processing components such as a baseband processor 122 and a speech CODEC 124. The baseband processor 122 may receive and process speech and/or other audio signals. For example, the baseband processor 122 may receive and process speech signals via a wireless connection and then provide the received and processed speech signals to the SEA 106. The baseband processor 122 may also receive audio data processed by the SEA 106 and transmit that processed audio wirelessly to one or more devices.

The speech CODEC 124 may perform speech and/or other audio coding and/or decoding. For example, speech CODEC 124 may receive and decode processed speech from the SEA 106 to be audibly output via a speaker 126. Likewise, audio or speech signals may be received by speech CODEC 124 via a microphone 128, then encoded and provided to the SEA 106.

The speaker 126 may include a one-way audio device used to transmit a signal from a source audio device to a destination. For example, speaker 126 may be a speaker connected to speech CODEC 124 used to output the processed speech or other signals from speech CODEC 124. In an example embodiment, speech CODEC 124 may transmit decoded, processed speech to speaker 126 which may play the speech in an audible format to a user. The user may then respond to the speech by speaking into the microphone 128. In an example embodiment, the user may be a human or a device capable of receiving and/or responding to speech.

The microphone 128 (e.g., mic 128) may be a microphone used to capture audio such as speech. For example, a user may speak into the microphone 128, the microphone 128 may then capture the speech and provide corresponding speech signals to speech CODEC 124 for processing. Speech CODEC 124 may then encode the speech signals, SEA 106 may process the encoded speech and baseband processor 122 may provide the processed and encoded speech to one or more other devices. In another example embodiment, the microphone 128 may be a device used to capture a signal containing speech over a wireless channel. For example the speaker 126 and/or the microphone 128 may be replaced by a transmission to/from one or more other devices.

The telephony device 102 may include a wireless transceiver 130 and an antenna 132 for wireless communication with one or more other devices. The wireless transceiver 130 may include a device or component with a transmitter and a receiver that may wirelessly transmit and receive radio frequency (RF) signals. For example, wireless transceiver 130 may transmit and receive RF signals, including audio information, via the antenna 132 over one or more channels. In an example embodiment, wireless transceiver 130 may include a Bluetooth compatible chip and may include speech enhancement or processing capability.

The antenna 132 may be coupled to the wireless transceiver 130 and may be configured to transmit and receive wireless RF signals. For example, the antenna 132 may transmit and receive RF signals over one or more channels, the signals being in accordance with one or more wireless protocols or standards, such as Bluetooth and/or WLAN.

According to an example embodiment, wireless transceiver 130 may include the baseband processor 122, SEA 106 and a speech CODEC 124. Although not shown, wireless transceiver 130 may include an RF front end to receive and demodulate wireless or RF signals. Further, the wireless transceiver 130 may modulate signals onto a carrier or RF frequency for transmission. The demodulated signals, as received by the wireless transceiver 130, may be input to baseband processor 122 for further processing.

As referenced above, the operating environment 104 may include the physical environment in which the telephony device 102 operates. As previously discussed, the operating environment 104 may impact audio processing and/or acoustic characteristics of the telephony device 102, including the speaker 126, microphone 128, antenna 132, wireless transceiver 130, baseband processor 122 and/or the speech CODEC 124, for example. As the operating environment 104 changes, the tuning engine 108 may determine how the changes affect the audio processing and/or audio characteristics of the telephony device 102 and provide the metrics 110, reflecting the changes, to the SEA 106. Then, based on the metrics 110, the SEA 106 may update its audio processing to account for and/or otherwise adjust for changes in the operating environment 104.

For example, the telephony device 102 may include two microphones (e.g., microphone 128) which may receive speech from a user. In such an arrangement, the SEA 106 may be configured to process incoming audio to account for speech received at both microphones. Over time, however, the sound quality received from one of the microphones may degrade in quality or one of the microphones may stop working altogether. However, the SEA 106 may continue processing audio based on a model that includes two fully functional microphones. In such a situation, the tuning engine 108, based on the metrics 110, may determine that the operating environment 104 has changed (e.g., one microphone stopped working) and may provide this information via the metrics 110 to the SEA 106. The SEA 106 may then retune itself, or conversely the tuning engine 108 and/or the telephony device 102 may retune the SEA 106, such that the SEA 106 accounts for the changed operating environment 104 (e.g., the inoperative microphone) and adjusts its audio processing accordingly.

The system 100 may determine whether the operating environment 104 in which a telephony device 102 operates has sufficiently changed such that the change impacts the acoustic quality, including the audio processing, of the telephony device 102 and/or one or more of its components. The system 100 may then provide metrics 110 or other parameters associated with how the telephony device 102 has been impacted such that SEA 106 may account and/or adjust for the changed operating circumstances of the telephony device 102 and consequently improve audio and/or speech processing.

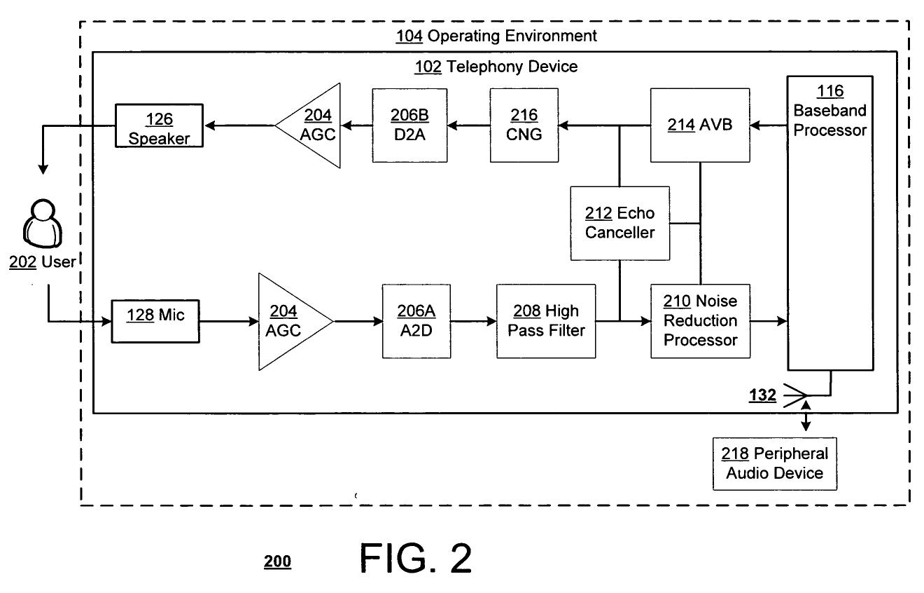

FIG. 2 is a block diagram of an example system 200 that provides for the automatic tuning of telephony devices according to an example embodiment.

The system 200 may include a user 202 who speaks into or otherwise provides audio via the microphone 128. The user 202 may be a person, automated response system, or other user that may use the telephony device 102. For example, the user 202 may speak into a Bluetooth headset (e.g., telephony device 102), the Bluetooth headset may then capture the speech via the microphone 128.

The microphone 128 may then provide signals corresponding to the received or captured speech to automatic gain control (AGC) 204. The AGC 204 may adjust the gain of incoming and/or outgoing signals to output a more average level signal. The AGC 204 may receive the speech signals from the microphone 128, adjust the gain of those signals, and provide the adjusted signals to an analog to digital converter (A2D) 206A.

The A2D 206A may include an audio compressor configured to encode analog audio signals, including speech, as received by the microphone 128, into digital audio signals. Similarly, a digital to analog converter (D2A) 206B may include an audio decompressor configured to decode digital audio signals into analog audio signals to be transmitted to and output via the speaker 126.

After being converted into a digital signal by the A2D 206A, the digital audio may be provided to a high pass filter 208. The high pass filter 208 may include a filter that passes high frequency signals, but attenuates or otherwise reduces signals with frequencies below a cutoff frequency. The high pass filter 208 may be used, for example, to filter out low frequency components of a signal below the cutoff frequency.

A noise reduction processor 210 may be configured to remove noise from a signal. Noise may include unwanted sound and/or energy received with a signal. For example, noise in an audio signal may be played back and heard as a hiss or a hum. An example noise reduction processor 210 may implement Dolby noise reduction.

An echo canceller 212 may be used to remove and/or suppress an echo from an audio signal. For example, audio output by the speaker 126 may be received by the microphone 128 and may cause an acoustic echo, which may be mitigated and/or removed by the echo canceller 212.

An automatic volume boost (AVB) 214 may be configured to adjust and/or boost the volume of an audio signal. For example, the AVB 214 may adjust the frequency, amplitude and/or duration of a signal to impact the signal's volume, or loudness.

A comfort noise generator (CNG) 216 may be configured to generate and/or otherwise insert artificial background noise into radio and/or wireless communications to fill in the silence in a transmission. For example, the generated comfort noise may be projected by the speaker 126 during periods where sound is not being received and/or processed from microphone 128. According to an example embodiment, the CNG 216 may be used to determine metrics (e.g., 110) associated with changes in the operating environment 104. For example, a tuning engine (e.g., 108) may determine how the telephony device 102 processes noise or audio generated by the CNG 216 and generate the metrics based on that processing.

According to an example embodiment, audio provided by the user 202 via the microphone 128 to the telephony device 102 may undergo one or more levels of speech enhancement (e.g., via the AGC 204, A2D 206A, high pass filter 208 and/or noise reduction processor 210) before it is provided to the baseband processor 122. The baseband processor 122 may then provide the processed audio to a wireless transceiver (e.g., 130) to be transmitted via antenna 132 to a peripheral audio device 218.

The peripheral audio device 218 may include a telephony device and/or other audio device that may be similar to the telephony device 102 and operationally coupled with the telephony device 102. For example, the peripheral audio device 218 may include a Bluetooth compatible mobile phone configured to communicate with a Bluetooth wireless headset (e.g., telephony device 102) via the antenna 132.

One or more of the speech enhancement or audio processing components (e.g., AGC 204, A2D 204A, D2A 204B, high pass filter 208, noise reduction 210, echo canceller 212, AVB 214 and CNG 216), as well as the peripheral audio device 218 may be configured based on the operating environment 104. For example, the peripheral audio device 218 may include a specific model and/or brand of mobile phone with a particular set of audio processing qualities. Then, for example, the peripheral audio device 218 may be replaced with a new peripheral audio device (e.g., the user 202 may replace the mobile phone with a new mobile phone). The new peripheral audio device 218 may differ from the previous one (e.g., the characteristics of audio processing of the device may differ), which may, in turn, effect the speech enhancement algorithms (SEAs), which may have been previously tuned to the old peripheral audio device 218. A tuning engine (e.g., 108) may then determine metrics (e.g., 110) associated with the performance of the telephony device 102 in the new operating environment (e.g., with the new peripheral audio device 218) and provide the metrics to one or more of the SEAs (e.g., 106) to be retuned. In other example embodiments, the SEAs may include different and/or additional blocks.

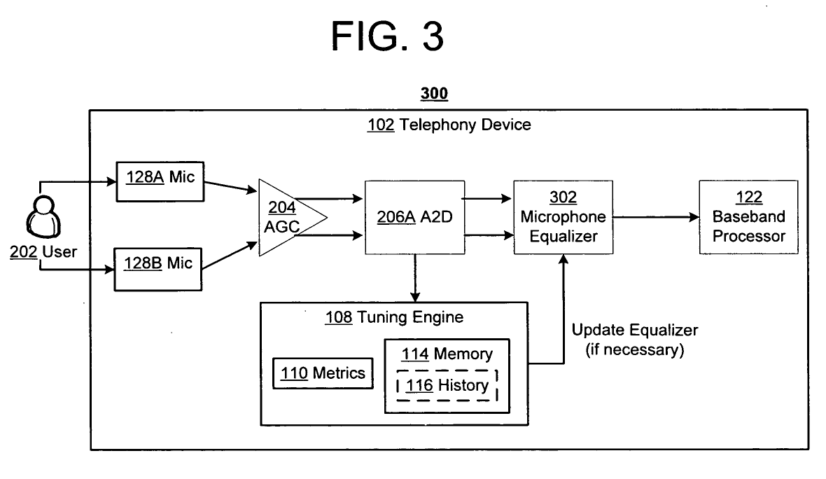

FIG. 3 is a block diagram of an example system 300 that provides for the automatic tuning of telephony devices according to an example embodiment.

The user 202 may speak into two microphones 128A and 128B, which may each capture speech provided by the user 202. The microphones 128A and 128B may then provide respective signals corresponding with the captured audio to the AGC 204, which may adjust respective gains of the signals and provide the gain adjusted signals to the A2D 206A.

The tuning engine 108 may then determine metrics 110 based on the audio data provided to and/or from the A2D 206A. For example, upon conversion of the analog audio to one or more digital signals by the A2D 206A, the tuning engine 108 may determine metrics 110 based on the digital signals. The metrics 110 may include characteristics of each signal produced, including for example, amplitude and frequency. The metrics 110 may then be stored in the history 116 in the memory 114.

One or more digital signals (as converted by the A2D 206A) may then be provided to a microphone equalizer 302. The microphone equalizer 302 may include a speech enhancement algorithm (SEA) configured to adjust one or more signals, and correspondingly and/or consequently audio associated with the signal(s). For example, the microphone equalizer 302 may boost and/or attenuate signals, adjust gain, bandwidth and/or frequency of signals, and/or may include a filter (such as a high pass filter (e.g., 208)). According to an example embodiment, the microphone equalizer 302 may receive two digital signals (one from each microphone 128A and 128B) from the A2D 206A. The microphone equalizer 302 may then combine and/or otherwise harmonize the two digital signals and provide or otherwise output a single equalized signal to the baseband processor 122.

The microphone equalizer 302 may be tuned to the telephony device 102 including the microphones 128A and 128B operating as expected. However, as time progresses and the telephony device 102 is in use, one of the microphones (e.g., microphone 128B) may stop functioning properly. In this situation, the microphone 128B may receive poor quality audio or no audio at all. The changed operating environment 104 may affect the audio processing of the microphone equalizer 302 as microphone 128B may no longer be operating as expected. Unless the microphone equalizer 302 is provided notice of the change(s) in the operating environment 104 (e.g., microphone 128B is no longer functioning), the processed audio output by the microphone equalizer 302 may degrade in acoustic quality.

Then, for example, the tuning engine 108 may detect an anomaly with the metrics 110 determined from the A2D 206A with only one working microphone 128A. The tuning engine 108 may determine, for example, that only a single signal is being processed, when previously two signals were being processed and/or that the second signal (e.g., from microphone 128B) is skewed or deviates in some way from previous signals, as may be determined based, at least in part, on the history 116.

The tuning engine 108 may then provide information that there is a problem with microphone 128B to the microphone equalizer 302 via the metrics 110. The microphone equalizer 302 may then update or retune itself. Alternatively, in other example embodiments, the microphone equalizer 302 may be updated or retuned by the tuning engine 108 based on the metrics 110. Such retuning may cause the microphone equalizer 302 to adjust its settings to account for only one operating microphone (e.g., 128A) rather than two, which may improve the quality of the audio processing by the microphone equalizer 302.

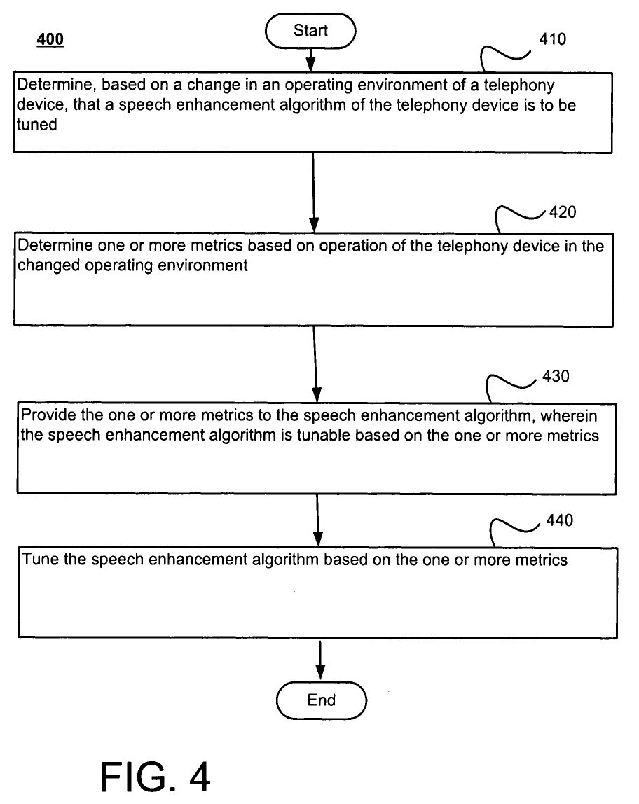

FIG. 4 is a flowchart illustrating example operations of the system 100 of FIG. 1. More specifically, FIG. 4 illustrates an example operational flow 400 representing example operations related to the system 100 of FIG. 1. It should be appreciated that the operational flow 400 is not limited to the example of system 100 and may be applied to other systems.

After a start operation, based, at least in part, on a change in an operating environment of a telephony device, it may be determined that a speech enhancement algorithm of the telephony device is to be tuned. For example, the tuning engine 108 may determine that there has been a change or variation in the operating environment 104 in which the telephony device 102 operates that may affect the performance of the speech enhancement algorithm (SEA) 106.

At block 420, one or more metrics may be determined based on operation of the telephony device in the changed operating environment. For example, the tuning engine 108 may determine the metrics 110 based on operation of the telephony device 102 in the operating environment 104. The metrics 110 may be determined by providing the telephony device 102 with the test data 112 for processing and then capturing the results of that processing.

At block 430, the one or more metrics may be provided to the speech enhancement algorithm, where the speech enhancement algorithm is tunable based, at least in part, on the one or more metrics. For example, the tuning engine 108 may then provide the metrics 110 to the SEA 106 and the SEA 106 may be tuned based on the metrics 110.

At block 440, the speech enhancement algorithm may be tuned based on the one or more metrics. For example, the SEA 106 may receive the metrics 110 and retune itself based on the metrics 110. In another example embodiment, the tuning engine 108 may tune the SEA 106 based on the metrics 110.

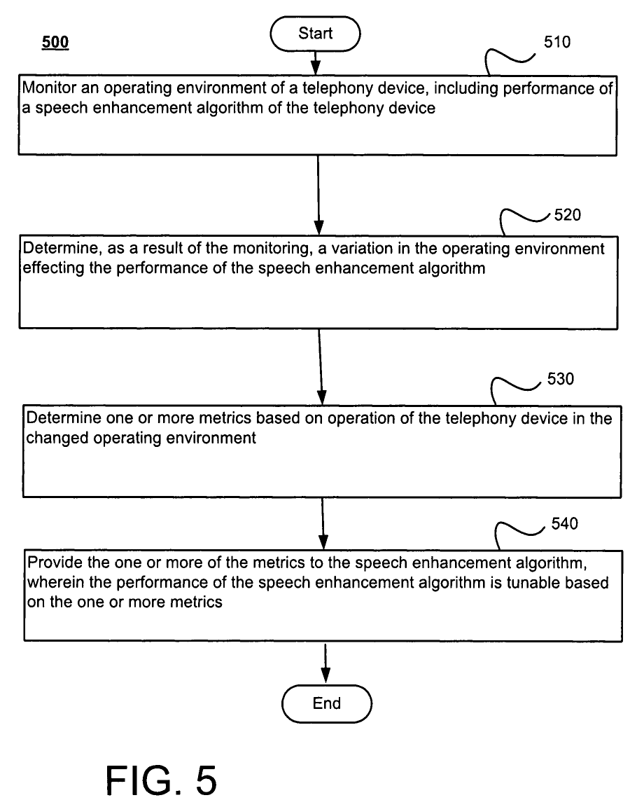

FIG. 5 is a flowchart illustrating example operations of the system of FIG. 1. More specifically, FIG. 5 illustrates an example operational flow 500 representing example operations related to the system 100 of FIG. 1. It should be appreciated that the operational flow 500 is not limited to the example of system 100 and may be applied to other systems.

With reference to FIG. 1, after a start operation, at block 510, an operating environment of a telephony device, including performance of a speech enhancement algorithm of the telephony device may be monitored. For example, the tuning engine 108 may monitor the operating environment 104 of the telephony device 102. The tuning engine 108 may, upon expiration of a timer 120 and/or upon setting the mode of operation 122 of the telephony device 102 to the tuning mode 122A, determine metrics 110 associated with performance of the SEA 106. The tuning engine 108 may then store the metrics 110 in a history 116 of a memory 114.

At block 520, as a result of the monitoring, a change in the operating environment affecting performance of the speech enhancement algorithm may be determined. For example, the tuning engine 108 may determine the metrics 110 and based upon a comparison of the metrics 110 to the history 116 and/or the threshold 118, the tuning engine 108 may determine that there has been a change or that there is variation in the operating environment 104 that affects the performance of the SEA 106. Alternatively, upon expiration of the timer 120 and/or placing the telephony device 102 into a tuning mode 122A, the tuning engine 108 may analyze the history 116 and determine that a change in the operating environment 104 has occurred.

At block 530, one or more metrics may be determined based on operation of the telephony device in the changed operating environment. For example, the tuning engine 108 may determine the metrics 110 based on the operation of the telephony device 102 in the operating environment 104. According to an example embodiment, the tuning engine 108 may provide the test data 112 to one or more portions (e.g., audio processing components) of the telephony device 102 and may determine the metrics 110 based on the captured processed audio test data.

At block 540, the one or more of the metrics may be provided to the speech enhancement algorithm, where performance of the speech enhancement algorithm is tunable based, at least in part, on the one or more metrics. For example, the tuning engine 108 may provide the metrics 110 to the SEA 106, where the SEA 106 is tunable based on the metrics 110.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A method comprising:
determining, based on a change in an operating environment of a telephony device, that a speech enhancement algorithm of the telephony device is to be tuned;
determining one or more metrics based on operation of the telephony device in the changed operating environment;
providing the one or more metrics to the speech enhancement algorithm, wherein the speech enhancement algorithm is tunable based on the one or more metrics; and
tuning the speech enhancement algorithm based on the one or more metrics.

2. The method of claim 1, wherein determining that the speech enhancement algorithm is to be tuned comprises determining that the change in the operating environment degrades performance of the speech enhancement algorithm.

3. The method of claim 1, wherein determining that the speech enhancement algorithm is to be tuned comprises identifying at least a material change, a shape change or a design change associated with the telephony device.

4. The method of claim 1, wherein determining that the speech enhancement algorithm is to be tuned comprises identifying a change associated with at least one of a supplementary device and a peripheral device of the telephony device.

5. The method of claim 1, wherein determining that the speech enhancement algorithm is to be tuned comprises identifying a change in operation of an audio component of the telephony device.

6. The method of claim 1, wherein determining that the speech enhancement algorithm is to be tuned comprises identifying the change in the operating environment upon expiration of a timer, the timer being associated with tuning of the speech enhancement algorithm.

7. The method of claim 1, wherein determining the one or more metrics comprises:
providing test data for processing by one or more components of the telephony device;
capturing results of the test data processing using one or more components of the telephony device; and
determining the one or more metrics based on the captured results.

8. The method of claim 1, wherein determining the one or more metrics comprises:
monitoring performance of the telephony device, including performance of the speech enhancement algorithm, over a period time; and
determining, based on the monitoring, the one or more metrics.

9. The method of claim 1, wherein tuning the speech enhancement algorithm comprises tuning the speech enhancement algorithm using a tuning engine.

10. A method comprising:
monitoring an operating environment of a telephony device, including performance of a speech enhancement algorithm of the telephony device;
determining, as a result of the monitoring, a change in the operating environment affecting the performance of the speech enhancement algorithm;
determining one or more metrics based on operation of the telephony device in the changed operating environment; and
providing the one or more metrics to the speech enhancement algorithm, wherein the performance of the speech enhancement algorithm is tunable based on the one or more metrics.

11. The method of claim 10, wherein the monitoring comprises monitoring, upon expiration of a timer associated with tuning the speech enhancement algorithm, the operating environment.

12. The method of claim 10, wherein the monitoring comprises:
determining the one or more metrics during a first time period;
determining the one or more metrics during a second time period; and
comparing the one or more metrics determined during the first time period with the one or more metrics determined during the second time period.

13. The method of claim 10, wherein the determining, as a result of the monitoring, comprises determining that the performance of the speech enhancement algorithm deviates beyond a threshold.

14. The method of claim 10, wherein the determining, as a result of the monitoring, comprises determining that the one or more metrics fall outside of a threshold.

15. The method of claim 10, wherein the determining, as a result of the monitoring, comprises determining a variation of one or more of the metrics wherein the one or more metrics deviate beyond a threshold associated with the one or more metrics.

16. The method of claim 15, wherein the determining, as a result of the monitoring, comprises:
determining that the speech enhancement algorithm is to be tuned; and
determining the variation.

17. An apparatus comprising:
a telephony device configured to operate in an operational mode or a tuning mode, the telephony device including a speech enhancement algorithm tunable based on one more metrics associated with performance of the telephony device operating in an operating environment,
wherein the telephony device, while operating in the tuning mode, is further configured to provide the one or more metrics associated with the performance of the telephony device operating in the operating environment to the speech enhancement algorithm for tuning.

18. The apparatus of claim 17, wherein the speech enhancement algorithm comprises at least one of an echo canceller, an echo suppressor, a noise reduction module, an automatic gain control module and an automatic volume boost module.

19. The apparatus of claim 17 wherein the telephony device is further configured to operate in the tuning mode upon occurrence of a variation in the performance of the telephony device operating in the operating environment.

20. The apparatus of claim 17, wherein the telephony device is further configured, when operating in the tuning mode, to monitor a performance of the speech enhancement algorithm, including monitoring the one or more metrics.
